(19) United States
(12) Patent Application Publication
(10) Pub. No.: US 2019/0143655 A1
(43) Pub. Date: May 16, 2019

(54) LAMINATED BODY AND FORMRED BODY

(71) Applicant: Swancor Ind. Co., Ltd., Nantou County (TW)

(72) Inventors: Yu-Tsan Tseng, Nantou County (TW); Sheng-Wei Shih, Nantou County (TW)

(73) Assignee: Swancor Ind. Co., Ltd., Nantou County (TW)

(21) Appl. No.: 15/892,377

(22) Filed: Feb. 8, 2018

(30) Foreign Application Priority Data
Nov. 16, 2017 (TW) 106139667

(51) Int. Cl. B32B 27/12; B32B 27/08; B32B 5/02; B32B 27/20

(52) U.S. Cl. CPC B32B 27/12; B32B 27/08; B32B 2250/42; B32B 27/20; B32B 2262/106; B32B 5/024

(57) ABSTRACT

A laminated body and a formed body formed by hot pressing the laminated body are provided. The laminated body includes a reinforcing material, a first matrix, and a second matrix located between the first matrix and the reinforcing material. The second matrix is bonded to the first matrix and the reinforcing material. The first matrix includes a first polymer. The second matrix includes a second polymer. The second polymer is a polymer formed by modifying the first polymer with a functional group.

### CROSS-REFERENCE TO RELATED APPLICATION

This application claims the priority benefit of Taiwan application serial no. 106139667, filed on Nov. 16, 2017. The entirety of the above-mentioned patent application is hereby incorporated by reference herein and made a part of this specification.

### BACKGROUND OF THE INVENTION

### Field of the Invention

The invention relates to a laminated body and a formed body, and more particularly, to a laminated body and a formed body with good mechanical properties and low material cost.

### Description of Related Art

A fiber-reinforced sheet formed by a matrix resin and a reinforcing fiber has good mechanical properties and is lightweight and resistant to corrosion, and is therefore extensively applied in the material of components in applications such as aircraft, cars, and sports equipment.

In the field of composite materials, a fiber-reinforced sheet is generally formed by hot pressing several layers of fibers and matrices (resins), but bonding between the fiber and the matrix is poor, such that the mechanical properties of the entire fiber-reinforced sheet are affected. For instance, CN101812686 (EP1679391A 1, US2007202255A1, WO2005031037A1) discloses a prepreg sheet formed by impregnating a reinforcing fiber in a resin composition, and an unmodified matrix (resin film) is used in the resin composition for bonding. When the resin composition for bonding (unmodified resin film) and the fiber form the prepreg sheet, the unmodified resin film is not readily seeped into the reinforcing fiber, and therefore interfacial bonding is poor. Therefore, how to solve the issue of poor interfacial bonding between the reinforcing material and the matrix is an important topic.

Many current research focus on the preparation of a prepreg using a resin (matrix) modified by a functional group and a fiber, and then a sheet is formed by hot pressing several layers of the prepreg and several layers of the resin modified by a functional group. However, the material cost of the resin modified by a functional group is high and is not readily commercialized, and the physical properties of the polymer itself are compromised after the resin is modified, such that the mechanical properties of the sheet cannot achieve the desired results.

For instance, TW201343742 (CN104321373A, EP2832778A1, KR20140129311A, US2015044470A1, WO2013147257A1) discloses a carbon fiber thermoplastic resin prepreg and a manufacturing method thereof, and a carbon fiber composite material using the prepreg. The thermoplastic resin composition used in the carbon fiber thermoplastic resin prepreg can include at least one resin of a modified resin of polypropylene resin, polyamide resin, or polypropylene resin, and a modified resin of polyamide resin. That is, the patent literature discloses using a modified resin as the material of the prepreg, and as described above, the material cost of the modified resin is high, commercialization is difficult, and the physical properties of the polymer itself are compromised after the resin is modified, such that the mechanical properties of the sheet cannot achieve the desired results.

Based on the above, how to develop a laminated body that can solve the issues of poor interfacial bonding between the matrix and the reinforcing material and compromised physical properties of the polymer itself after the resin used as the matrix is modified while lowering material cost is an important research topic.

### SUMMARY OF THE INVENTION

The invention provides a laminated body and a formed body with good mechanical properties and low material cost. In the invention, the mechanical properties of the formed body are related to the interfacial bonding between a matrix and a reinforcing material and the physical properties of the resin itself used as the matrix, and in the invention, the formed body is formed via a specific arrangement of the laminated body. As a result, the issues of poor interfacial bonding between the matrix and the reinforcing material and compromised physical properties of the polymer itself resulting from the modification of the resin used as the matrix are eliminated, and material cost can be lowered at the same time.

Specifically, the invention provides a laminated body including a reinforcing material, a first matrix, and a second matrix located between the first matrix and the reinforcing material. The second matrix is bonded to the first matrix and the reinforcing material. The first matrix includes a first polymer. The second matrix includes a second polymer. The second polymer is a polymer formed by modifying the first polymer with a functional group.

The invention further provides a laminated body including one or more groups of first matrices, two or more groups of second matrices, and a plurality of reinforcing materials, wherein the quantity of the first matrix is N groups, the quantity of the second matrix is 2N groups, the quantity of the reinforcing materials is N+1, and N is a positive integer. The one or more groups of first matrices are respectively interspersed between the plurality of reinforcing materials such that one group of the one or more groups of first matrices is located between every two of the plurality of reinforcing materials. The two or more groups of second matrices are respectively interspersed between the plurality of reinforcing materials and the one or more groups of first matrices such that one group of the two or more groups of second matrices is located between each of the plurality of reinforcing materials and each group of the one or more groups of first matrices. The one or more groups of first matrices include a first polymer, the two or more groups of second matrices include a second polymer, and the second polymer is a polymer formed by modifying the first polymer with a functional group.

In an embodiment of the invention, each of the plurality of reinforcing materials is bonded to an adjacent group of second matrix of the two or more groups of second matrices.

In an embodiment of the invention, each group of the one or more groups of first matrices is bonded to an adjacent group of second matrix of the two or more groups of second matrices.

In an embodiment of the invention, the first polymer and the second polymer are thermoplastic polymers.

In an embodiment of the invention, the reinforcing material is a carbon fiber, a graphite fiber, an aromatic polyamide fiber, a nylon fiber, a polyester fiber, a glass fiber, a boron fiber, an aluminum oxide fiber, a silicon nitride fiber, or a metallic fiber.

The invention further provides a laminated body including a matrix and a prepreg bonded to the surface of the matrix. The prepreg contains a resin and a reinforcing material. The matrix includes a first polymer, the resin includes a second polymer, and the second polymer is a polymer formed by modifying the first polymer with a functional group.

The invention further provides a laminated body including one or more groups of matrices and a plurality of prepregs, wherein the quantity of the matrix is M groups, the quantity of the plurality of prepregs is M+1, and M is a positive integer. The one or more groups of matrices are respectively interspersed between the plurality of prepregs, such that every two of the plurality of prepregs are both bonded to one group of the one or more groups of matrices. Each of the plurality of prepregs contains a resin and a reinforcing material. The matrix of the one or more groups of matrices includes a first polymer, the resin includes a second polymer, and the second polymer is a polymer formed by modifying the first polymer with a functional group.

The invention further provides a formed body formed by hot pressing the laminated body.

Based on the above, the invention provides a laminated body and a formed body, wherein the reinforcing materials, the second matrix, and the first matrix are stacked in order; or the prepregs and the matrices are laminated, wherein the second polymer in the laminated body is designed as a polymer formed by modifying the first polymer with a functional group. As a result, the laminated body and the formed body of the invention have the following features:

(1) Bonding between the matrices and the reinforcing materials, between the matrices, and between the prepregs and the matrices is good.

(2) The matrix contains a polymer having a greater molecular structure rigidity (polymer not modified by a functional group), and therefore the mechanical properties of the formed body can overall be effectively improved without significantly compromising the physical properties of the polymer itself while retaining the bonding between the matrices and the reinforcing materials.

(3) Since the amount of the expensive polymer modified by a functional group is smaller, the effect of lowered material cost can be achieved.

Accordingly, the laminated body and the formed body of the invention have the features of good mechanical properties and low material cost.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross section of a laminated body shown according to the first embodiment of the invention.

FIG. 2 is a cross section of a laminated body shown according to the second embodiment of the invention.

FIG. 3 is a cross section of the laminated body of example 1.

FIG. 4 is a cross section of the laminated body of comparative example 1.

FIG. 5 is a cross section of the laminated body of comparative example 2.

FIG. 6 is a cross section of the laminated body of comparative example 3.

FIG. 7 is a cross section of the laminated body of comparative example 4.

FIG. 8A is a flexural strength comparison chart of example 1 and comparative examples 1 to 4.

FIG. 8B is a flexural strength percentage comparison chart of example 1 and comparative examples 1 to 4.

FIG. 9A is a flexural modulus comparison chart of example 1 and comparative examples 1 to 4.

FIG. 9B is a flexural modulus percentage comparison chart of example 1 and comparative examples 1 to 4.

FIG. 10A is an interlaminar shear strength comparison chart of example 1 and comparative examples 1 to 4.

FIG. 10B is an interlaminar shear strength percentage comparison chart of example 1 and comparative examples 1 to 4.

### DESCRIPTION OF THE EMBODIMENTS

In the field of composite materials, fiber (cloth) is collectively referred to as a “reinforcement or reinforcing material”, and the resin (polymer) part is collectively referred to as a “matrix”.

### First Embodiment

In the first embodiment, a laminated body includes one or more groups of first matrices, two or more groups of second matrices, and a plurality of reinforcing materials, wherein the quantity of the first matrix is N groups, the quantity of the second matrix is 2N groups, the quantity of the reinforcing materials is N+1, and N is a positive integer.

In the present embodiment, the laminating method of the laminated body is as follows: the one or more groups of first matrices are respectively interspersed between the plurality of reinforcing materials such that one group of the one or more groups of first matrices is located between every two of the plurality of reinforcing materials. The two or more groups of second matrices are respectively interspersed between the plurality of reinforcing materials and the one or more groups of first matrices such that one group of the two or more groups of second matrices is located between each of the plurality of reinforcing materials and each group of the one or more groups of first matrices.

Moreover, each of the plurality of reinforcing materials is bonded to an adjacent group of second matrix of the two or more groups of second matrices, and each group of first matrix of the one or more groups of first matrices is bonded to an adjacent group of second matrix of the two or more groups of second matrices. As a result, the bonding between the first matrix and the second matrix and between the second matrix and the reinforcing material is good.

In the following, the first matrix is also referred to as an “unmodified matrix”, and the second matrix is also referred to as a “modified matrix”. Moreover, the first matrix and the second matrix can be resin films.

The reinforcing material can be a carbon fiber, a graphite fiber, an aromatic polyamide fiber, a nylon fiber, a polyester fiber, a glass fiber, a boron fiber, an aluminum oxide fiber, a silicon nitride fiber, or a metallic fiber. Among these fibers, carbon fiber or graphite fiber is preferred.

The quantity of each group of first matrix is not particularly limited, and can be one sheet of first matrix or a plurality of sheets of first matrices. Moreover, the quantity of each group of second matrix is not particularly limited, and can be one sheet of second matrix or a plurality of sheets of second matrices. Moreover, in terms of improving the mechanical properties of the formed body, the quantity of each group of first matrix is preferably greater than the quantity of each group of second matrix.

The first matrix includes a first polymer, and the second matrix includes a second polymer. In consideration of the bonding between the second matrix and the reinforcing material, the second polymer of the second matrix is a polymer modified by a functional group. Moreover, in consideration of the bonding between the second matrix and the first matrix, the main chain of the second polymer of the second matrix is the same as the main chain of the first polymer of the first matrix. Therefore, the second polymer is preferably a polymer formed by modifying the first polymer with a functional group. Here, the “polymer modified by a functional group” refers to modifying a side chain structure of a polymer with a functional group without changing the main chain. The polymer modified by a functional group of the invention is not particularly limited. For example, according to the surface properties of the reinforcing material, various functional groups (polar/nonpolar, positive/negative charge, etc.) can be modified on the side chains of a polymer of the second matrix to improve the impregnation properties and the interfacial bonding strength of the second matrix and the reinforcing material.

As a result, by designing the second polymer as a polymer formed by modifying the first polymer with a functional group, the bonding of the second matrix is good with both the reinforcing material and the first matrix, that is, the second matrix is equivalent to a buffer layer between the reinforcing material and the first matrix. Moreover, via the first matrix, the rigidity of the molecular structure of the unmodified polymer can be retained to effectively improve the overall mechanical properties of the formed body formed by the laminated body. Therefore, in comparison to a prepreg in which only a modified matrix is used in the prior art, by including both the modified matrix and the unmodified matrix, impregnation of the laminated body of the invention in the reinforcing material can be improved, and the mechanical properties of the formed body formed by the laminated body can be improved. Moreover, the amount of the expensive modified matrix can also be reduced to achieve the effect of lowered material cost.

The first polymer and the second polymer can be thermoplastic polymers or thermosetting polymers. In consideration of the processability of a subsequent process of the laminated body, the first polymer and the second polymer are preferably thermoplastic polymers.

The thermoplastic polymer is, for instance, polyethylene (PE), polypropylene (PP), polystyrene (PS), polymethylmethacrylate (PMMA), polyvinyl chloride (PVC), polyamide (PA) (such as nylon 6 or nylon 66 made by DuPont), polycarbonate (PC), polytetrafluoroethylene (PTFE) (Teflon), polyethylene terephthalate (PET or PETE), or polyoxymethylene (POM). In the laminated body or the resulting formed body, based on a total of 100 wt % of the first polymer and the second polymer, the content of the second polymer is 5 wt % to 60 wt %.

The laminated body of the invention can form a formed body after hot pressing, wherein the reinforcing material is impregnated with the first matrix and the second matrix. Based on the total weight of the formed body, a content Rc of the resin is 20% to 60%.

The thickness of the formed body of the invention is not particularly limited, and the thickness of the formed body can be adjusted based on product requirement.

The resin content of the formed body of the invention is not particularly limited, and can be adjusted based on product requirement.

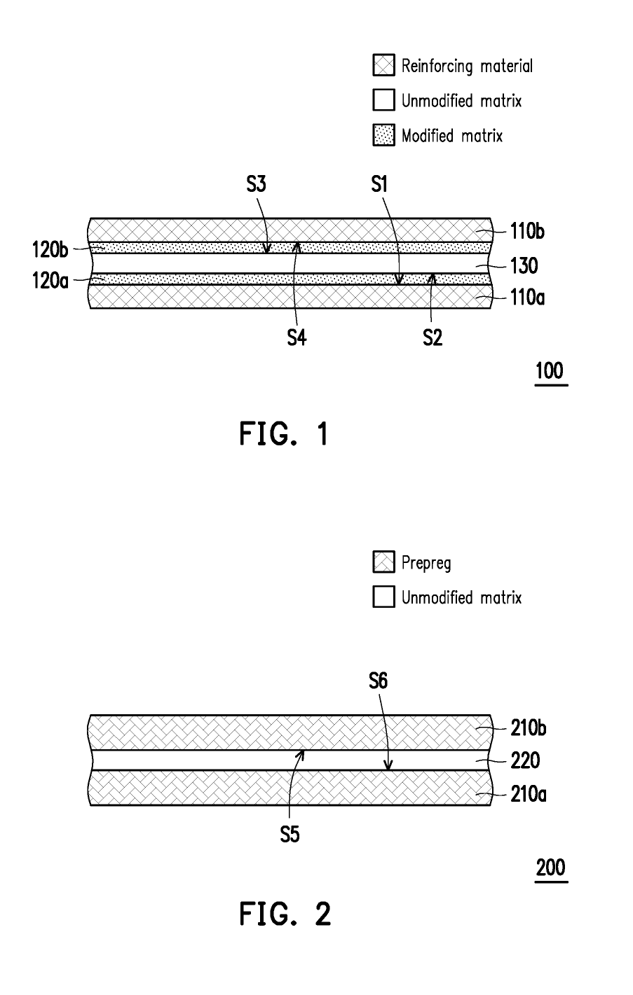

FIG. 1 is a cross section of a laminated body shown according to the first embodiment of the invention.

Referring to FIG. 1, the quantity N of a laminated body 100 of the present embodiment is equal to 1. Specifically, the laminated body 100 of the present embodiment includes, in an order, from bottom to top, a reinforcing material 110a, a modified matrix 120a, an unmodified matrix 130, a modified matrix 120b, and a reinforcing material 110b. More specifically, the unmodified matrix 130 is located between the reinforcing material 110a and the reinforcing material 110b. The modified matrix 120a is located between the reinforcing material 110a and the unmodified matrix 130, and a first surface S1 and a second surface S2 of the modified matrix 120a are respectively bonded to the reinforcing material 110a and the unmodified matrix 130. The modified matrix 120b is located between the unmodified matrix 130 and the reinforcing material 110b, and a third surface S3 and a fourth surface S4 of the modified matrix 120b are respectively bonded to the unmodified matrix 130 and the reinforcing material 110b.

It should be mentioned that, in the laminated body of the invention, the matrix adjacent to the reinforcing material needs to be a modified matrix to retain the impregnation properties for the reinforcing material. If the matrix adjacent to the reinforcing material is an unmodified matrix, then the impregnation properties for the reinforcing material is poor. Moreover, by disposing an unmodified matrix at a side of the modified matrix opposite to the reinforcing material, the mechanical properties of the formed body formed by the laminated body can be improved and the amount of the expensive modified matrix can be reduced to achieve the effect of lowered material cost.

### Second Embodiment

The difference between the second embodiment and the first embodiment is that, a reinforcing material is first impregnated with a modified matrix to form prepregs, and then an unmodified matrix is inserted between the prepregs to form a laminated body. Next, the laminated body can form a formed body after hot pressing.

Specifically, in the second embodiment, the laminated body includes one or more groups of unmodified matrices and a plurality of prepregs. The quantity of the unmodified matrices is M groups, the quantity of the plurality of prepregs is M+1, and M is a positive integer.

In the present embodiment, the laminating method of the laminated body is as follows: one or more groups of unmodified matrices are respectively interspersed between the plurality of prepregs such that one group of unmodified matrix of the one or more groups of unmodified matrices is located between every two prepregs of the plurality of prepregs. Moreover, each of the prepregs in the plurality of prepregs is bonded to the surface of an adjacent unmodified matrix of the one or more groups of unmodified matrices.

Each of the plurality of prepregs contains a modified resin and a reinforcing material. The unmodified matrix of the one or more groups of unmodified matrices includes a first polymer. The modified resin includes a second polymer, and the second polymer is a polymer formed by modifying the first polymer with a functional group.

Similar to the first embodiment, in the first embodiment, the impregnation properties of the modified matrix for the reinforcing material is good, and therefore the bonding between the two is good. Moreover, by designing the second polymer as a polymer formed by modifying the first polymer with a functional group, the bonding between the prepregs and the unmodified matrix is also good.

Moreover, via the unmodified matrix, the rigidity of the molecular structure of the unmodified polymer can be retained to effective improve the overall mechanical properties of the formed body formed by the laminated body. Therefore, in comparison to a prepreg in which only a modified matrix is used in the prior art, by including both an unmodified matrix and a modified matrix, the laminated body of the invention can have impregnation properties for the reinforcing material, and the mechanical properties of the formed body formed by the laminated body can be improved. Moreover, the amount of the expensive modified matrix can also be reduced to achieve the effect of lowered material cost.

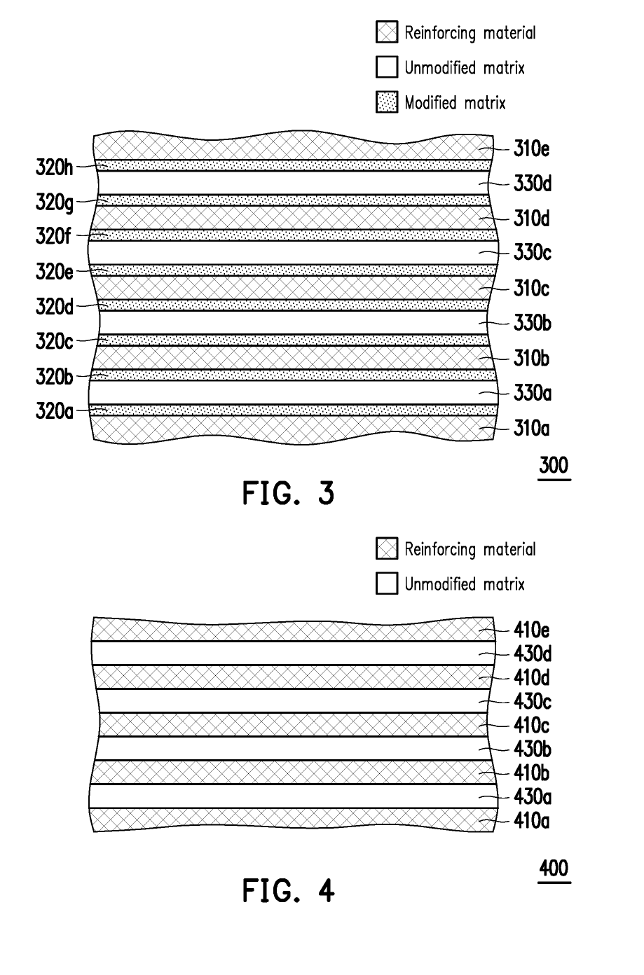

FIG. 2 is a cross section of a laminated body shown according to the second embodiment of the invention.

Referring to FIG. 2, the quantity M of a laminated body 200 of the present embodiment is equal to 1. Specifically, the laminated body 200 of the present embodiment includes, in an order, from bottom to top, a prepreg 210a, an unmodified matrix 220, and a prepreg 210b. More specifically, a reinforcing material is impregnated with the modified matrix to form the prepreg 210a and the prepreg 210b, the unmodified matrix 220 is located between the prepreg 210a and the prepreg 210b, and an upper surface S5 and a lower surface S6 of the unmodified matrix 220 are respectively bonded to the prepreg 210a and the prepreg 210b.

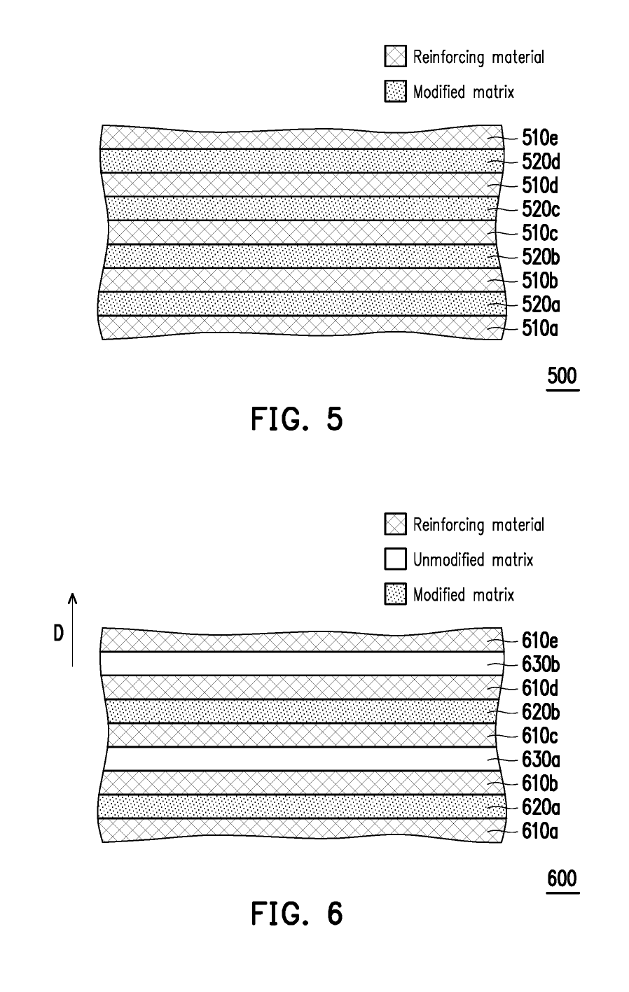

The following examples are used to further describe the invention. However, it should be understood that, the examples are only exemplary, and are not intended to limit the implementation of the invention. Moreover, the cross sections of the laminated bodies of FIG. 3 to FIG. 7 only schematically show the laminating method of the laminated body and do not represent the actual number of each layer.

### EXAMPLE 1

FIG. 3 is a cross section of a laminated body 300 of example 1. The laminated body 300 of example 1 is laminated according to the laminating method of a laminated body of the first embodiment of the invention. Specifically, referring to FIG. 3, the laminated body 300 includes, in an order, from bottom to top, a reinforcing material 310a, a modified matrix 320a, an unmodified matrix 330a, a modified matrix 320b, a reinforcing material 310b, a modified matrix 320c, an unmodified matrix 330b, a modified matrix 320d, a reinforcing material 310c, a modified matrix 320e, an unmodified matrix 330c, a modified matrix 320f, a reinforcing material 310d, a modified matrix 320g, an unmodified matrix 330d, a modified matrix 320h, and a reinforcing material 310e.

Moreover, in example 1, 3K woven carbon fiber cloth having a basis weight of 200 g/m² is used as the reinforcing material, a modified nylon 6 resin film is used as the modified matrix, and an unmodified nylon 6 resin film is used as the unmodified matrix. The laminated body 300 of example 1 is hot pressed using a hot press machine to form a formed body. In example 1, based on the total weight of the formed body, the content Rc of the resin is 47%. The thickness of the formed body is 3.0 mm.

Referring to Table 1 in the following, according to ASTM D790, the formed body of example 1 has a flexural strength of 664 MPa and a flexural modulus of 51.3 GPa. According to ISO14130, the interlaminar shear strength (ILSS) of the formed body of example 1 is 50.3 MPa.

### COMPARATIVE EXAMPLE 1

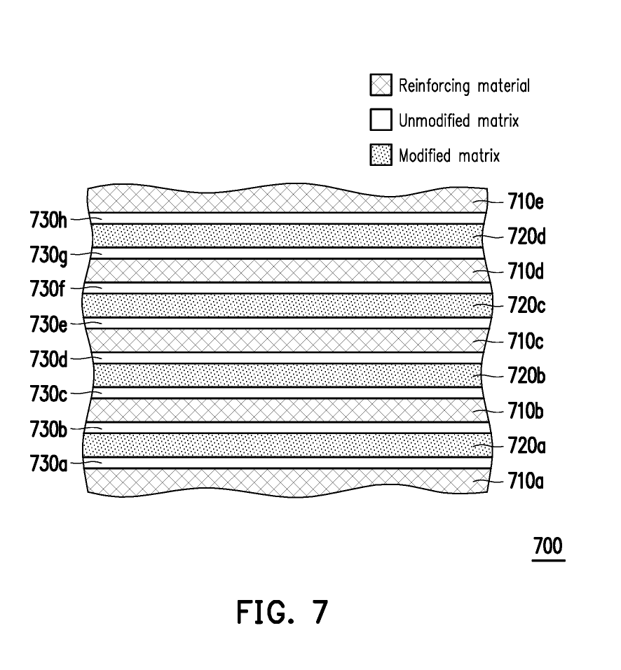

FIG. 4 is a cross section of a laminated body 400 of comparative example 1. The laminated body 400 of comparative example 1 is laminated by alternately stacking a reinforcing material and an unmodified matrix. Specifically, referring to FIG. 4, the laminated body 400 includes, in an order, from bottom to top, a reinforcing material 410a, an unmodified matrix 430a, a reinforcing material 410b, an unmodified matrix 430b, a reinforcing material 410c, an unmodified matrix 430c, a reinforcing material 410d, an unmodified matrix 430d, and a reinforcing material 410e.

Moreover, in comparative example 1, 3K woven carbon fiber cloth having a basis weight of 200 g/m² is used as the reinforcing material, and an unmodified nylon 6 resin film is used as the unmodified matrix. The laminated body 400 of comparative example 1 is hot pressed using a hot press machine to form a formed body. In comparative example 1, based on the total weight of the formed body, the content Rc of the resin is 47%. The thickness of the formed body is 3.0 mm.

Referring to Table 1 in the following, according to ASTM D790, the formed body of comparative example 1 has a flexural strength of 472 MPa and a flexural modulus of 46.6 GPa. According to ISO14130, the ILSS of the formed body of comparative example 1 is 43.3 MPa.

### COMPARATIVE EXAMPLE 2

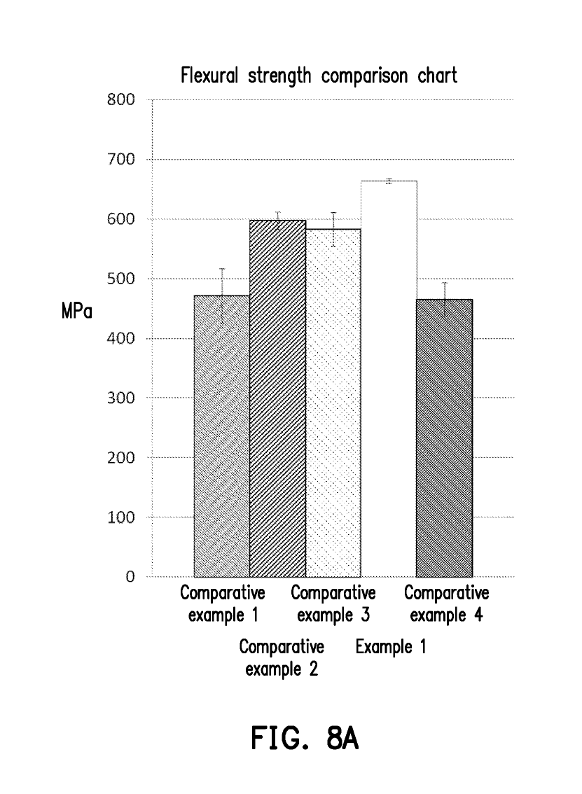

FIG. 5 is a cross section of a laminated body 500 of comparative example 2. The laminated body 500 of comparative example 2 is laminated by alternately stacking a reinforcing material and a modified matrix. Specifically, referring to FIG. 5, the laminated body 500 includes, in an order, from bottom to top, a reinforcing material 510a, a modified matrix 520a, a reinforcing material 510b, a modified matrix 520b, a reinforcing material 510c, a modified matrix 520c, a reinforcing material 510d, a modified matrix 520d, and a reinforcing material 510e.

Moreover, in comparative example 2, 3K woven carbon fiber cloth having a basis weight of 200 g/m² is used as the reinforcing material, and a modified nylon 6 resin film is used as the modified matrix. The laminated body 500 of comparative example 2 is hot pressed using a hot press machine to form a formed body. In comparative example 2, based on the total weight of the formed body, the content Re of the resin is 47%. The thickness of the formed body is 3.0 mm.

According to Table 1 in the following, the formed body of comparative example 2 has a flexural strength of 586 MPa and a flexural modulus of 50.6 GPa according to ASTM D790. According to ISO14130, the ILSS of the formed body of comparative example 2 is 47.3 MPa.

### COMPARATIVE EXAMPLE 3

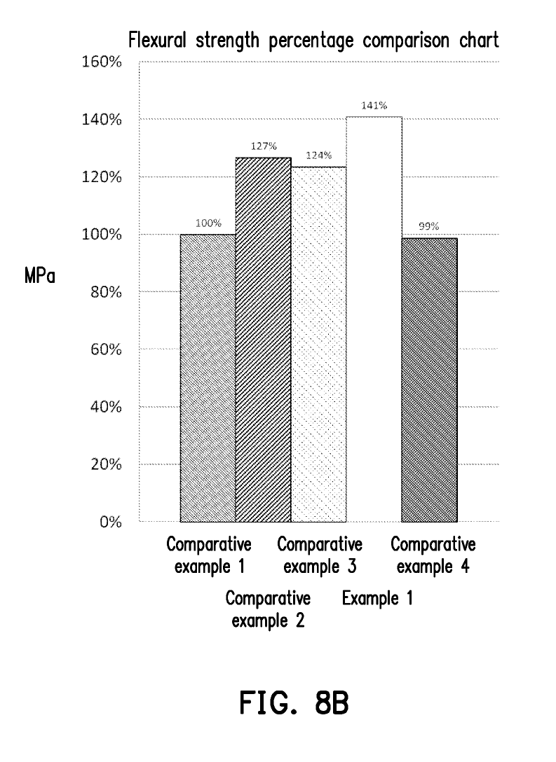

FIG. 6 is a cross section of a laminated body 600 of comparative example 3. The laminated body 600 of comparative example 3 is laminated by alternately stacking a modified matrix and an unmodified matrix in a thickness direction D with a reinforcing material in between. In other words, in comparative example 3, a modified matrix and an unmodified matrix are respectively located at two sides of each reinforcing material.

Specifically, referring to FIG. 6, the laminated body 600 includes, in an order, from bottom to top, a reinforcing material 610a, a modified matrix 620a, a reinforcing material 610b, an unmodified matrix 630a, a reinforcing material 610c, a modified matrix 620b, a reinforcing material 610d, an unmodified matrix 630b, and a reinforcing material 610e in the thickness direction D.

Moreover, in comparative example 3, 3K woven carbon fiber cloth having a basis weight of 200 g/m² is used as the reinforcing material, a modified nylon 6 resin film is used as the modified matrix, and an unmodified nylon 6 resin film is used as the unmodified matrix. The laminated body 600 of comparative example 3 is hot pressed using a hot press machine to form a formed body. In comparative example 3, based on the total weight of the formed body, the content Rc of the resin is 47%. The thickness of the formed body is 3.0 mm.

According to Table 1 in the following, the formed body of comparative example 3 has a flexural strength of 569 MPa and a flexural modulus of 47.1 GPa according to ASTM D790. According to ISO14130, the ILSS of the formed body of comparative example 3 is 47.7 MPa.

### COMPARATIVE EXAMPLE 4

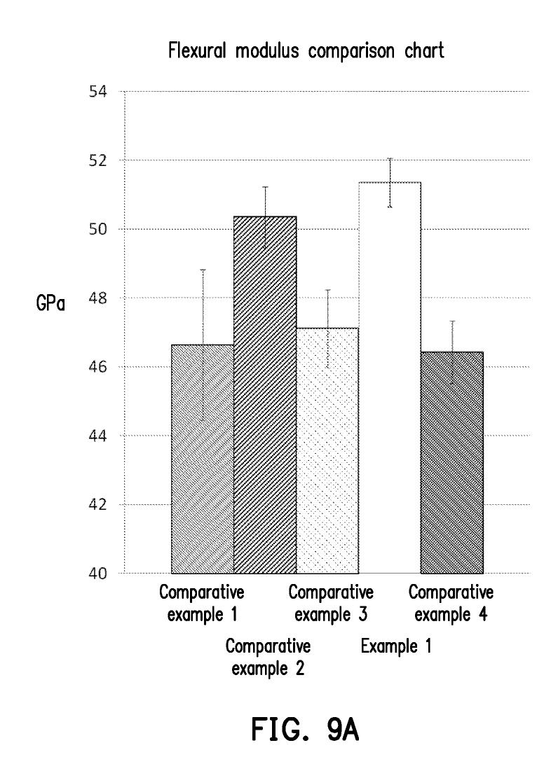

FIG. 7 is a cross section of a laminated body 700 of comparative example 4.

The difference between the laminated body 700 of comparative example 4 and the laminated body 300 of example 1 of FIG. 3 is that, the modified matrix in FIG. 3 is replaced with an unmodified matrix, and the unmodified matrix is replaced with a modified matrix. In other words, for the laminated body 700, an unmodified matrix is located at two sides adjacent to the reinforcing material, and a modified matrix is located between any two unmodified matrices. Specifically, referring to FIG. 7, the laminated body 700 includes, in an order, from bottom to top, a reinforcing material 710a, an unmodified matrix 730a, a modified matrix 720a, an unmodified matrix 730b, a reinforcing material 710b, an unmodified matrix 730c, a modified matrix 720b, an unmodified matrix 730d, a reinforcing material 710c, an unmodified matrix 730e, a modified matrix 720c, an unmodified matrix 730f, a reinforcing material 710d, an unmodified matrix 730g, a modified matrix 720d, an unmodified matrix 730h, and a reinforcing material 710e.

Moreover, in comparative example 4, 3K woven carbon fiber cloth having a basis weight of 200 g/m² is used as the reinforcing material, a modified nylon 6 resin film is used as the modified matrix, and an unmodified nylon 6 resin film is used as the unmodified matrix. The laminated body 700 of comparative example 4 is hot pressed using a hot press machine to form a formed body. In comparative example 4, based on the total weight of the formed body, the content Rc of the resin is 47%. The thickness of the formed body is 3.0 mm.

Referring to Table 1 in the following, according to ASTM D790, the formed body of comparative example 4 has a flexural strength of 465 MPa and a flexural modulus of 46.4 GPa. According to ISO14130, the ILSS of the formed body of comparative example 4 is 45.2 MPa.

### <Evaluation Results>

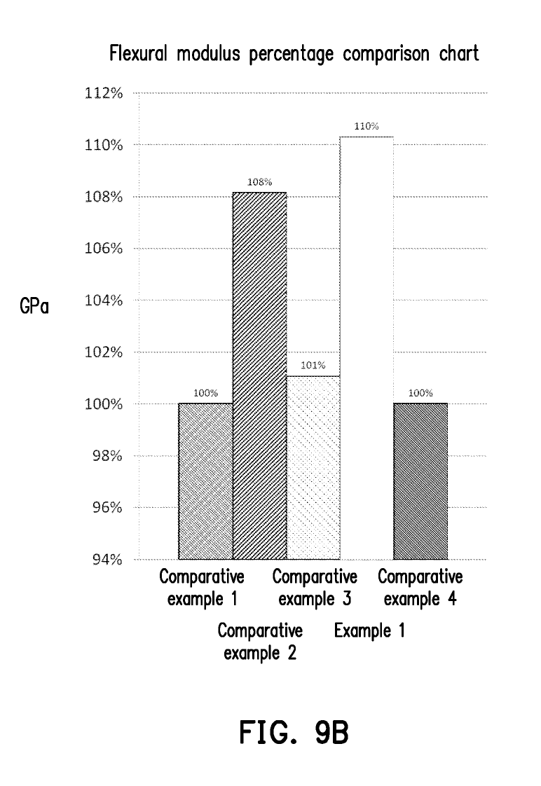

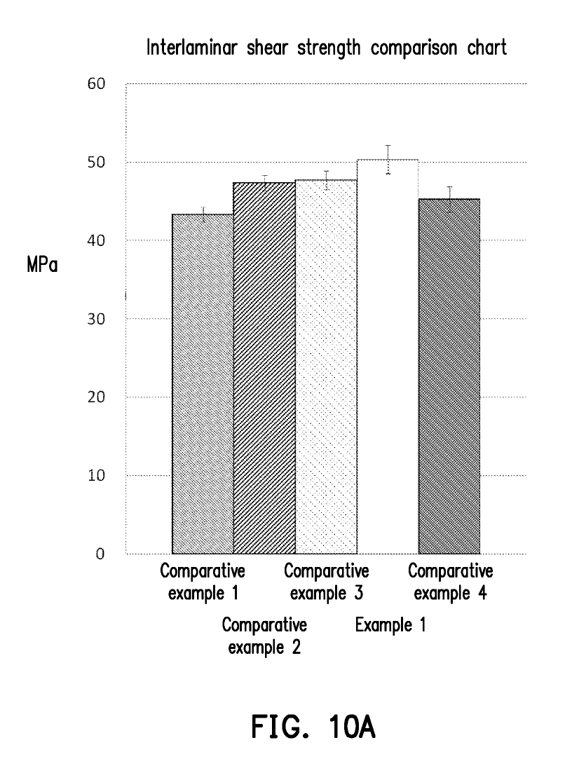

FIG. 8A is a flexural strength comparison chart of example 1 and comparative examples 1 to 4. FIG. 8B is a flexural strength percentage comparison chart of example 1 and comparative examples 1 to 4. FIG. 9A is a flexural modulus comparison chart of example 1 and comparative examples 1 to 4. FIG. 9B is a flexural modulus percentage comparison chart of example 1 and comparative examples 1 to 4. The flexural strength and the flexural modulus of example 1 are significantly greater than those of comparative examples 1 to 4, indicating the formed body of example 1 has better mechanical properties.

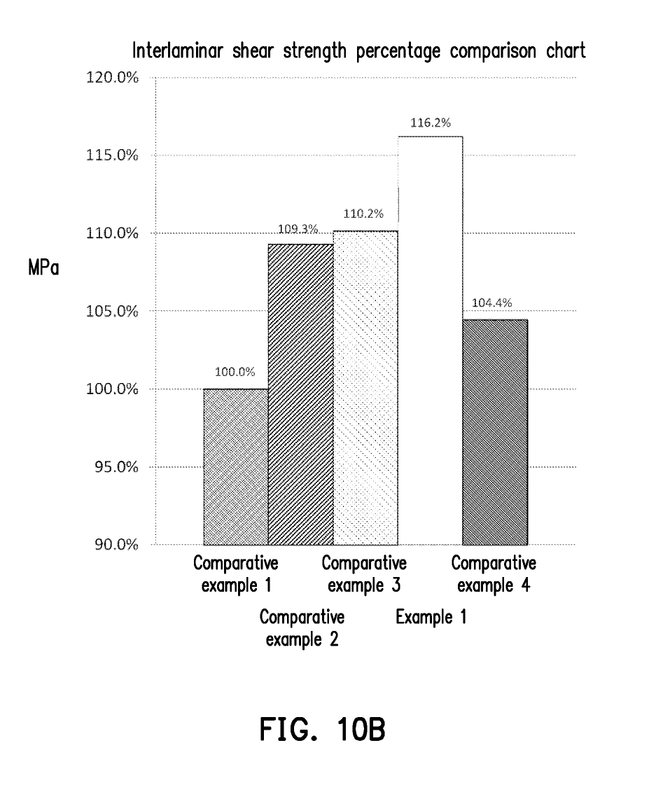

FIG. 10A is an interlaminar shear strength comparison chart of example 1 and comparative examples 1 to 4. FIG. 10B is an interlaminar shear strength percentage comparison chart of example 1 and comparative examples 1 to 4. The ILSS is used for evaluating whether the formed body is delaminated, and delamination refers to the separation of two reinforcing materials. Factors affecting delamination include (1) bonding between the reinforcing material and the matrix, and (2) physical properties of the matrix (resin film) itself The ILSS of example 1 is also significantly greater than that of comparative examples 1 to 4, indicating the formed body of example 1 has better mechanical properties.

Please refer to Table 1, FIG. 8A, FIG. 8B, FIG. 9A, FIG. 9B, FIG. 10A, and FIG. 10B. Comparing comparative example 1 and comparative example 2, in comparative example 2, a modified matrix having better bonding and impregnation properties with fiber cloth is used, and therefore the flexural strength, flexural modulus, and ILSS of comparative example 2 are all better than those of comparative example 1, that is, the mechanical properties of comparative example 2 are better than those of comparative example 1.

Comparing example 1 and comparative example 3, the flexural strength, flexural modulus, and ILSS of example 1 are better than those of comparative example 3. Therefore, the placement locations of the unmodified matrix and the modified matrix are very important. Specifically, similar to example 1, the modified matrix needs to be located at two sides of the reinforcing material, and the unmodified matrix is disposed between the modified matrices to ensure the bonding and impregnation properties between the matrices and the reinforcing material to achieve the effect of improved mechanical properties.

Comparing example 1 and comparative example 2, the flexural strength and the flexural modulus of example 1 are both better than those of comparative example 2. In comparative example 2, a prepreg formed only by a modified matrix in prior art is used. Although only modified matrices are used in comparative example 2, and bonding and impregnation properties between the modified matrices and the reinforcing material are better, the molecular structure of the modified matrix is modified such that the rigidity of the polymer itself is compromised, and therefore the mechanical properties are worse. On the other hand, in addition to the modified matrix improving bonding and impregnation properties, example 1 also contains an unmodified matrix having better polymer rigidity, and therefore the mechanical properties of the formed body can be effectively improved under the premise of retaining both bonding and impregnation properties between the matrices and the reinforcing material. Moreover, the ILSS of example 1 is also better than that of comparative example 2, and therefore the reinforcing material is separated to a greater degree in comparative example 2 than in example 1. This result directly proves that, similar to comparative example 2, when only modified matrices are used, the physical properties of the polymer itself are compromised in the modified matrix, thus resulting in worse mechanical properties.

On the other hand, similar to example 1, when an unmodified matrix is used as the main body for the matrix and only some modified matrices are used, bonding between the matrices and the reinforcing material can be retained without significantly compromising the physical properties of the polymer itself to effectively improve the mechanical properties of the formed body.

Comparing example 1 and comparative example 4, the flexural strength, flexural modulus, and ILSS of example 1 are all better than those of comparative example 4. In comparative example 4, the modified matrix in example 1 is replaced with an unmodified matrix, and the unmodified matrix is replaced with a modified matrix. In comparative example 4, an unmodified matrix is disposed at two sides of the reinforcing material, and therefore the bonding and impregnation properties between the matrices and fiber cloth may be unsatisfactory, such that mechanical properties are worse. Therefore, the placement locations of the unmodified matrix and the modified matrix are very important. Specifically, similar to example 1, the modified matrix needs to be located at two sides of the reinforcing material, and the unmodified matrix is disposed between the modified matrices to ensure the bonding and impregnation properties between the matrices and the reinforcing material to achieve the effect of improved mechanical properties.

Moreover, it can be known from FIG. 8A, FIG. 8B, FIG. 9A, FIG. 9B, FIG. 10A, and FIG. 10B that, the flexural strength, flexural modulus, and ILSS of the formed body of example 1 are all better than those of comparative examples 1 to 4. Therefore, the formed body formed by the laminated body of the invention has good mechanical properties. Moreover, the error bars on the bar charts of FIG. 8A, FIG. 9A, and FIG. 10A include a distribution range for ten or more samples, and a shorter error bar indicates better material stability. Example 1 of FIG. 8A, FIG. 9A, and FIG. 10A shows that the material stability of the formed body formed by the laminated body of the invention is good.

TABLE 1

| | | Compar- | Compar- | Compar- | Compar- |
|---|---|---|---|---|---|
| | Ex- | ative | ative | ative | ative |
| | ample 1 | example 1 | example 2 | example 3 | example 4 |
| Flexural | 664 | 472 | 586 | 569 | 465 |
| strength (MPa) | | | | | |
| Flexural | 141 | 100 | 127 | 124 | 99 |
| strength | | | | | |
| percentage (%) | | | | | |
| Flexural | 51.3 | 46.6 | 50.6 | 47.1 | 46.4 |
| modulus (GPa) | | | | | |
| Flexural | 110 | 100 | 108 | 101 | 100 |
| modulus | | | | | |
| percentage (%) | | | | | |
| ILSS (MPa) | 50.3 | 43.3 | 47.3 | 47.7 | 45.2 |
| ILSS | 116.2 | 100.0 | 109.3 | 110.2 | 104.4 |
| percentage (%) | | | | | |

Based on the above, the invention provides a laminated body and a formed body, wherein by stacking a reinforcing material, a modified matrix, and an unmodified matrix in order, the bonding and impregnation properties between the modified matrix and the reinforcing material are good, and the bonding between the modified matrix and the unmodified matrix is good.

The invention further provides a laminated body and a formed body, wherein the bonding and impregnation properties between the matrices and the reinforcing material are retained via a prepreg preformed by the modified matrix and the reinforcing material. The prepreg is laminated with the unmodified matrix. Since the prepreg contains a modified resin, the bonding between the prepreg and the unmodified matrix is also good.

It should be mentioned that, the laminated body of the invention contains an unmodified matrix, and therefore the issue of worse mechanical properties caused by compromised physical properties of the polymer itself due to the prepreg formed only by modified matrices in prior art can be alleviated. Moreover, in comparison to the prepreg formed by only using a modified matrix in prior art, the amount of the expensive modified matrix is reduced in the laminated body of the invention, and therefore the effect of lowered material cost can also be achieved.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A laminated body, comprising:
a reinforcing material;
a first matrix; and
a second matrix located between the first matrix and the reinforcing material and bonded to the first matrix and the reinforcing material,
the first matrix comprises a first polymer, the second matrix comprises a second polymer, and the second polymer is a polymer formed by modifying the first polymer with a functional group.

2. A laminated body, comprising:
one or more groups of first matrices, wherein a quantity of the first matrix is N groups, and N is a positive integer;
two or more groups of second matrices, wherein a quantity of the second matrix is 2N groups; and
a plurality of reinforcing materials, wherein a quantity of the reinforcing materials is N+1,
wherein the one or more groups of first matrices are respectively interspersed between the plurality of reinforcing materials such that one group of the one or more groups of first matrices is located between every two of the plurality of reinforcing materials,
the two or more groups of second matrices are respectively interspersed between the plurality of reinforcing materials and the one or more groups of first matrices such that one group of the two or more groups of second matrices is located between each of the plurality of reinforcing materials and each group of the one or more groups of first matrices,
the one or more groups of first matrices comprise a first polymer, the two or more groups of second matrices comprise a second polymer, and the second polymer is a polymer formed by modifying the first polymer with a functional group.

3. The laminated body of claim 2, wherein each of the plurality of reinforcing materials is bonded to an adjacent group of second matrix of the two or more groups of second matrices.

4. The laminated body of claim 2, wherein each group of the one or more groups of first matrices is bonded to an adjacent group of second matrix of the two or more groups of second matrices.

5. The laminated body of claim 2, wherein the first polymer and the second polymer are thermoplastic polymers.

6. The laminated body of claim 2, wherein the reinforcing material is a carbon fiber, a graphite fiber, an aromatic polyamide fiber, a nylon fiber, a polyester fiber, a glass fiber, a boron fiber, an aluminum oxide fiber, a silicon nitride fiber, or a metallic fiber.

7. A formed body formed by hot pressing the laminated body of claim 2.

8. A laminated body, comprising:
a matrix; and
a prepreg bonded to a surface of the matrix,
wherein the prepreg contains a resin and a reinforcing material,
the matrix comprises a first polymer, the resin comprises a second polymer, and the second polymer is a polymer formed by modifying the first polymer with a functional group.

9. A laminated body, comprising:
one or more groups of matrices, wherein a quantity of the matrix is M groups; and
a plurality of prepregs, wherein a quantity of the plurality of prepregs is M+1, and M is a positive integer,
wherein the one or more groups of matrices are respectively interspersed between the plurality of prepregs, such that every two of the plurality of prepregs are both bonded to one group of the one or more groups of matrices,
wherein each of the plurality of prepregs contains a resin and a reinforcing material,
the matrix in the one or more groups of matrices comprises a first polymer,
the resin comprises a second polymer, and the second polymer is a polymer formed by modifying the first polymer with a functional group.

10. The laminated body of claim 9, wherein the first polymer and the second polymer are thermoplastic polymers.

11. The laminated body of claim 9, wherein the reinforcing material is a carbon fiber, a graphite fiber, an aromatic polyamide fiber, a nylon fiber, a polyester fiber, a glass fiber, a boron fiber, an aluminum oxide fiber, a silicon nitride fiber, or a metallic fiber.

12. A formed body formed by hot pressing the laminated body of claim 9.
